(19) United States
(12) Patent Application Publication
(10) Pub. No.: US 2026/0082410 A1
(43) Pub. Date: Mar. 19, 2026

(54) DYNAMIC CHANNEL CAPABILITY

(71) Applicant: AIRTIES S.A.S., Paris (FR)

(72) Inventors: Mehmet Sukru KURAN, Istanbul (TR); Firat BIRLAK, Istanbul (TR); Adil YILDIZ, Istanbul (TR)

(73) Assignee: AIRTIES SAS, Paris (FR)

(21) Appl. No.: 19/104,138

(22) PCT Filed: Aug. 15, 2023
(86) PCT No.: PCT/IB2023/058204

§ 371 Date: Feb. 14, 2025

Related U.S. Application Data
(60) Provisional application No. 63/398,056, filed on Aug. 15, 2022.

(51) Int. Cl. H04W 72/51; H04W 72/02

(52) U.S. Cl. CPC H04W 72/51; H04W 72/02

(57) ABSTRACT

As discussed herein, there may be one or more methods, systems, and/or devices for Dynamic Channel Capability (DCC) mechanism. In some cases, a DCC may be implemented in conjunction with a Cloud-assisted Channel Selection (CACS) mechanism. In some cases, a DCC may be utilized by one or more 802.11 access points (AP). A DCC mechanism may, or may enable another entity to, dynamically enable or disable the usage of Dynamic Frequency Selection (DFS) channels (e.g., in CACS mechanisms) to mitigate performance issues faced by one or more user devices, such as stations (STA), that cannot operate on such DFS channels.

### CROSS-REFERENCE TO RELATED APPLICATIONS

This application claims the benefit of U.S. Provisional Application No. 63/398,056, filed Aug. 15, 2022, the contents of which are incorporated herein by reference.

### BACKGROUND

The Dynamic Frequency Selection (DFS) channels are used in 802.11 networks to dynamically select frequencies that are not occupied by other communication devices. This allows for increased network throughput and improved coverage. The DFS channels are enabled or disabled through manual configuration of the Access Point (AP). However, this is often an arduous task and requires frequent manual adjustments. Additionally, as technology evolves and the need for more bandwidth increases, it has become necessary to provide a more dynamic and automated way to enable and disable the usage of DFS channels in 802.11 networks.

### SUMMARY

As discussed herein, there may be one or more methods, systems, and/or devices for Dynamic Channel Capability (DCC) mechanism. In some cases, a DCC may be implemented in conjunction with a Cloud-assisted Channel Selection (CACS) mechanism. In some cases, a DCC may be utilized by one or more 802.11 access points (AP). A DCC mechanism may, or may enable another entity to, dynamically enable or disable the usage of Dynamic Frequency Selection (DFS) channels (e.g., in CACS mechanisms) to mitigate performance issues faced by one or more user devices, such as stations (STA), that cannot operate on such DFS channels.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates an example of a CACS system architecture with a DCC addition;

FIG. 2 illustrates an example of a Dynamic Channel Capability Engine (DCCE) architecture;

FIG. 3 illustrates an example state transition diagram of a Band Usage Analyzer; and

FIG. 4 illustrates an example process based on one or more examples described herein.

### DETAILED DESCRIPTION

As discussed herein, there may be one or more methods, systems, and/or devices for a Dynamic Channel Capability (DCC) mechanism. In some cases, a DCC may be implemented in conjunction with a Cloud-assisted Channel Selection (CACS) mechanism. In some cases, a DCC may be utilized by one or more 802.11 access points (AP). A DCC mechanism may, or may enable another entity to, dynamically enable or disable the usage of Dynamic Frequency Selection (DES) channels (e.g., in CACS mechanisms) to mitigate performance issues faced by one or more user devices, such as stations (STA), that cannot operate on DES channels.

In an example situation, a DES channel may be available to use for a given wireless network (e.g., WLAN, WMN, etc.), but there may be a DES-incapable client device which may force the use of a 2.4 GHz interface, instead of the DES channel, reducing the overall performance of the wireless network. Accordingly, there is a need for one or more methods, devices, and/or systems to address this and other related issues.

As discussed herein, one or more terms disclosed in Table 1

TABLE 1

| Term | Definition |
|---|---|
| AW-CCD | Activity-Weighted Channel Capabilities Determination |
| CACS | Cloud-assisted Channel Selection |
| CNC | Cloud Network Controller |
| CTD | Client Type Determination |
| DCC | Dynamic Channel Capability |
| DCCE | Dynamic Channel Capability Engine |
| Dual-band | Access Point with one 2.4 GHz and one 5 GHz interfaces |
| AP | |
| MC | Metric Calculator |
| Tri-band | Access Point with one 2.4 GHz and two 5 GHz interfaces |
| AP | |
| Tri-band | Access Point with one 2.4, one 5, and one 6 GHz interfaces |
| AP 6E | |
| WCCD | WMN-Wide Channel Capability Determination |
| AP | Access Points, which is interchangeable with Extenders, |
| | Set-top-boxes with AP capabilities, and devices with |
| | Access Point capabilities. |
| DFS | Dynamic Frequency Selection |
| GHz | Giga Hertz |
| OUI | Organizationally unique identifier |
| RSSI | Received Signal Strength Indicator |
| STA | Client Station |
| WMN | Wireless Mesh Network, which is equivalent to a mesh |
| | WLAN |

In some cases, a DCC mechanism may be a cloud-side add-on to a CACS mechanism. The DCC mechanism may build upon a two-component system that a CACS considers: a Wireless Local Area Network (WLAN) (e.g., such as a Wireless Mesh Network (WMN)) of at least one AP and a Cloud Network Controller (CNC) for the WLAN. In one instance, the WLAN may be composed of multiple APs each employing one or more radio interfaces (e.g., for a WMN). For illustration purposes, WMN may be referred to herein, however, the techniques and examples are intended to apply to a non-mesh wireless networks as well. For example, each AP may have one or more interfaces operating at the 2.4 GHz band, and/or one or more interfaces operating at the 5 GHz band. In one example, each AP may have one 2.4 GHz band interface, and one or two 5 GHz band interfaces. The WMN may be formed among the APs via one of or more of the interfaces, using one or more interfaces as a wireless backbone/backhaul. For example, the mesh aspect may be formed among the APs of their 5 GHz band interfaces, utilizing this interface as a wireless backbone. The WMN may be connected to the CNC via the Internet. A DCC may add a second cloud component to this system, named the Dynamic Channel Capability Engine (DCCE). As discussed herein, DCC and DCCE may be interchangeable. The DCCE may operate on a cloud server, with one or more processors, one or more storage mediums, one or more memory, and one or more communication interfaces (e.g., ethernet, fiber, wireless, etc.).

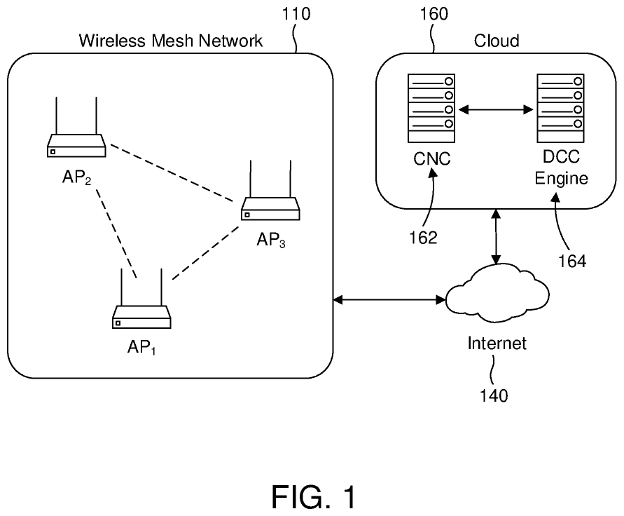

FIG. 1 illustrates an example system topology utilizing a DCCE. As shown, there may be a WMN 110, a Cloud 160, and the Internet 140. The WMN 110 may be operatively coupled, via the Internet 140, to the Cloud 160. The Cloud 160 may include a CNC 162 and a DCC/DCCE 164.

Generally, the DCCE may acquire, store, and process data related to STA and/or WMN related information, and calculate intermediate metrics. The DCCE may determine activity-weighted STA channel capabilities, define WMN-wide channel capability based on the data. The DCCE may interact (e.g., communicate) with the CACS CNC in order to allow or ban one or more DFS channels in a given WMN.

In some cases, the DCC and the CNC may operate under one physical or virtual computing unit (e.g., the cloud) which may comprise hardware, such as one or more processors, one or more random access memory, one or more storage means (e.g., HDD, SDD, NVME, etc.), and one or more communication interfaces (e.g., ethernet, fiber, coaxial cable, Wi-Fi, cellular, etc.). As discussed herein, from the perspective of a home network (e.g., a WMN), the cloud may gather data and send instructions to be carried out by a device in the WMN (e.g., AP or STA). The cloud (e.g., server, device, computer, etc.) may refer to both the DCC and the CNC. In some cases, the DCC and CNC may be physically or virtually separate. In some cases, the DCC and the CNC may be combined (e.g., virtually and/or physically). As discussed herein, a module or mechanism may be a function, computer program, application, or the like, carried out by hardware. As discussed herein, a module may have its own module (e.g., a sub-module); each module may perform an action (e.g., use/collect/distribute data, perform analysis, send, receive, determine, etc.), have a requirement, and/or have a conditional trigger. What each mode does is further discussed herein. All modules may operate off of the same hardware, or different hardware, depending on the deployment and configuration. For example, any action taken by a module may in practice be performed by the cloud entity; alternatively/additionally, and/or any action taken by a module may in practice be performed by the CNC and/or the DCC (e.g., depending on whether they are separate, or combined). Modules may work in conjunction with one another. Modules may exchange information; the exchange of information may be between physically or virtually separate entities, or, within one physical or virtual entity.

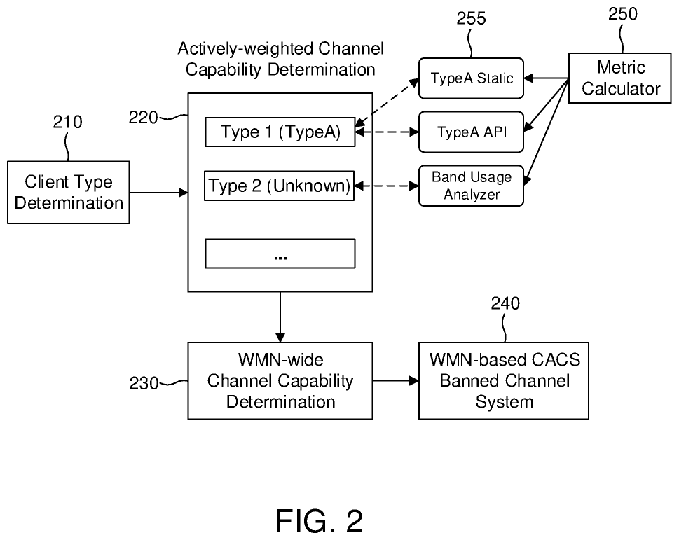

FIG. 2 illustrates an example of Dynamic Channel Capability Engine (DCCE) architecture. As shown, there may be a CTD 210 performing one or more actions (e.g., receive data and/or make a determination based on the data), at which point it may send information to the AW-CCD 220. The AW-CCD 220 may have one or more types each associated with a specific module in 255 All of these modules depend on the common metrics calculated by, the MC 250 Specifically, the modules 255 (e.g., TypeA Static, TypeA API, Band Usage Analyzer, etc.) of the MC 250 may be used for the one or more of the types, as stored/received/determined by the AW-CCD 220. From the AW-CCD 220, information is sent to the WMN-wide channel capability 230, where a determination is made (e.g., receive data and/or make a determination based on the data), and information is sent to the WMN-based CACS 240 (e.g., in order to ban a channel in the WMN).

In the example of FIG. 2, a given module may send/receive information internally and externally, depending on the function it is performing. For example, a module may receive information from a WMN, which means (e.g., said another way where the module is a component of the cloud or some other sub-entity) that the cloud receives information. One module may process this information, and then send the processed information to another module for further processing. The sending between modules may, in one case, be the storing of and retrieval of information in a storage means.

The responsibilities of DCCE may be carried out by several modules as described herein. The DCCE may comprise a client type determination (CTD) module, metric calculator (MC) module, Activity-Weighted Channel Capability Determination (AW-CCD) module, WMN-wide Channel Capability Determination (WCCD) module, WMN-based CACS Banned Channel System module, and/or any other module disclosed herein.

A client type determination (CTD) module may be responsible for processing STA identification data (e.g., MAC address, friendly name) and determining the type of each STA.

A metric calculator (MC) module may utilize topology information to generate several slot analytic values for each STA connected to an AP within each WMN. It may periodically process the gathered data and calculate each analytic value.

The Activity-Weighted Channel Capability Determination (AW-CCD) module may be composed of several modules that each work on a particular type of STA with the same input and output format. Each module may use the slot analytics as its input, and may generate a single Boolean value called activity weighted DFS (AW-DFS) flag for a given STA. A rule-based logic may be utilized to determine which module should be run for each type of STA.

The WMN-wide Channel Capability Determination (WCCD) module may aggregate the AW-DFS flags of each STA within the WMN and set the WMN-wide DFS flag for this WMN.

The WMN-based CACS Banned Channel System module may use the WMN-wide DFS flag for each WMN and generate a banned channel list (e.g., DFS Channel) for each WMN as an input for the CNC system of CACS.

The DCCE may employ one or more STA metrics within the topology information (e.g., STA entries), such as: RxBytes (i.e., received traffic amount), Band, and RSSI. The DCCE may also employ one or more WMN metrics within the topology information (e.g., channel5 describing the channel of the 5 GHz interface, channel52 describing the channel of the second 5 GHz interface).

As discussed herein, metrics may be acquired from one or more AP of a given wireless network. There may be a program running on the AP that gathers this data (e.g., monitor, receive, store, etc.) and then relays/sends the data to the cloud (e.g., CNC/DCC).

There may be one or more requirements of each DCCE module in the overall DCCE architecture, as disclosed herein.

The DCCE Client Type Determination (CTD) module may have one or more operational requirements, operating parameters, and/or may perform one or more actions.

For example, the CTD may have a list of all STAs within the cloud development environment.

For example, the CTD may have access, for each STA, to various per-STA identification parameters (e.g., these parameters may include the MAC address of the STA's Wi-Fi interface as well as a user-friendly name; and/or, there may be one or more other identification parameters).

For example, the CTD may keep a Type value whose default value is NULL for each STA.

For example, the CTD may have access to type determination rules, which may be configurable on a cloud development basis; a type determination rule may be composed of a name, a comparison logic over the per-STA identification parameters, associated type name, and/or, a unique priority level.

For example, the CTD may require that a type determination rule set includes an organizationally unique identifier (OUI) rule and/or a friendly name rule (e.g., see Table 2). Note, regex refers to Regular Expressions; as such, the string “TypeA.Tv” may refer to any string that has 1 character between the words “TypeA” and “Tv”; the character may also be blank.

TABLE 2

| Rule name | Comparison Logic | Type | Priority Level |
|---|---|---|---|
| OUI rule | OUI of MAC address is | TypeA | 1 |
| | within a particular OUI list | | |
| Friendly | Friendly name contains a | TypeA | 2 |
| name rule | particular regex (e.g., “TypeA.TV” | | |
| . . . | . . . | . . . | . . . |

For example, the CTD may require that a company's OUI list is configurable on a cloud development basis. An example of its default list is provided in Table 3.

TABLE 3
OUI List

| OUI (hex) | OUI (base 16) |
|---|---|
| AA-BB-CC | AABBCC |
| BB-CC-DD | BBCCDD |

For example, the CTD may periodically process all STAs whose type is NULL or “Unknown” by applying the comparison logic of each type determination rule sorted by their priority levels to the per-STA identification parameters. For instance, if the comparison logic of a particular type determination rule returns a “true”, the CTD may set the type of that STA to the type determination rule's type value. Then, it may stop checking the type determination rules of lower priority levels for that STA. For instance, if the comparison logic of all type determination rules return “false”, the CTD may set the type of that STA to “Unknown”.

For example, the CTD may have a period of operation that is a non-configurable parameter (e.g., DCCEOperationPeriod) with a value of some unit of time, such as 1 day.

For example, the CTD may skip a comparison, while processing STAs according to a particular type determination rule, if one STA has missing data that is needed for its comparison logic, and it's result may be assumed to be “false”.

The DCCE Metric Calculator (MC) module may have one or more operational requirements, operating parameters, and/or may perform one or more actions.

For example, the MC may have a list of all STAs within the cloud development environment.

For example, the MC may have, for each STA, access to per-STA topology parameters as described herein, on a 1-minute granularity.

For example, the MC may have, for each WMN, access to per-WMN topology parameters as described herein.

For example, the MC may periodically process, for each STA, one or more per-STA and per-WMN topology parameters. The MC may then generate several intermediate values. The MC may then use these intermediate values to generate per slot analytics. The MC may then use the per slot analytics to generate per day analytics.

For example, the MC may have one or more intermediate values, such as those that may be generated on a 1-minute granularity while others are generated once per STA.

In one or more cases, there may be one or more intermediate values generated on a 1-minute granularity.

is5InDFS is an example of the one or more intermediate values, and represents if the 5 GHz interface of the dual-band AP the STA is connected to is operating at a DFS channel at time slot t. It has a value of “1” if the AP is operating at a DFS channel during time slot t, and “0” otherwise. It may be calculated as follows:

$$isIn5DF {S}_{t} = \{ \begin{matrix}1 & , & config ( t ) \cdot channel 5 ∈ {ℂ}_{DFS} \\ 0 & , & otherwise\end{matrix} \qquad Eq . 1$$

Where [symbol] _{DFS} represents the set of 5 GHz DFS channels and shall include all the channels given Table 4.

TABLE 4
Set of 5 GHz DFS channels (i.e., [symbol] _{DFS})
Channel No

52
56
60
64
100
104
108
112
116
120
124
128
132
136
140
144

is5FHInDFS is an example of the one or more intermediate values, and represents if the front haul 5 GHz interface of the tri-band AP the STA is connected to is operating at a DFS channel at time slot t. It has a value of “1” if the front-haul 5 GHz interface of the tri-band AP is operating at a DFS channel during time slot t, and “0” otherwise. It may be calculated as follows:

$${isIn5FHDFS}_{t} = \{ \begin{matrix}1 & , & config ( t ) \cdot channel 52 ∈ {ℂ}_{DFS} \\ 0 & , & otherwise\end{matrix} \qquad Eq . 2$$

Where [symbol] _{DFS} represents the set of 5 GHz DFS channels and shall include all the channels given in Table 4.

is5BHInDFS is an example of the one or more intermediate values, and represents if the back haul 5 GHz interface of the tri-band AP the STA is connected to is operating at a DFS channel at time slot t. It has a value of “1” if the back-haul 5 GHz interface of the tri-band AP is operating at a DFS channel during time slot t, and “0” otherwise. It may be calculated as follows:

$${isIn5FHDFS}_{t} = \{ \begin{matrix}1 & , & config ( t ) \cdot channel 5 ∈ {ℂ}_{DFS} \\ 0 & , & otherwise\end{matrix} \qquad Eq . 3$$

Where [symbol] _{DFS} represents the set of 5 GHz DFS channels and shall include all the channels given in Table 4.

isConnectedtoSingle5GHzAP is an example of the one or more intermediate values, and represents if the AP this STA connected to is either a Dual-band AP or a Tri-band 6E AP. It may be calculated as below:

$${isConnectedtoSingle5GHzAP}_{t} = \{ \begin{matrix}1 & , & config ( t ) \cdot ownaddr 52 g is undef . \\ 0 & , & otherwise\end{matrix} \qquad Eq . 4$$

isConnectedtoTwo5GHzAP is an example of the one or more intermediate values, and represents if the AP this STA connected to is a Tri-band AP. It shall be calculated as follows:

$${isConnectedtoTwo5GHzAP}_{t} = \{ \begin{matrix}1 & , & config ( t ) \cdot ownaddr 52 g is valid MAC \\ 0 & , & otherwise\end{matrix} \qquad Eq . 5$$

activeMesh is an example of the one or more intermediate values, and represents if there is an active Wi-Fi mesh for this AP over the last 5 minutes. It may be calculated as follows:

$$stats . {activeMesh}_{t} = \{ \begin{matrix}1 & , & ( {\sum }_{t = 0}^{- 4} {mr}_{t , t - 1} ) > 0 \\ 0 & , & otherwise\end{matrix} \qquad Eq . 6$$

Where

$$m {r}_{t , t - 1} = \{ \begin{matrix}1 & , & ( mesh ( t ) . rxbytes - mesh ( t - 1 ) . rxbytes ) > 0 \\ 0 & , & otherwise\end{matrix}$$

activeMesheth is an example of the one or more intermediate values, and represents if there is an active Ethernet mesh for this AP over the last 5 minutes. It may be calculated as follows:

$$stats . {activeMesheth}_{t} = \{ \begin{matrix}1 & , & ( {\sum }_{t = 0}^{- 4} m e {r}_{t , t - 1} ) > 0 \\ 0 & , & otherwise\end{matrix} \qquad Eq . 7$$

Where

$${mer}_{t , t - 1} = \{ \begin{matrix}1 & , & ( mesheth ( t ) . rxbytes - mesheth ( t - 1 ) . rxbytes ) > 0 \\ 0 & , & otherwise\end{matrix}$$

isAPStandAloneGW is an example of the one or more intermediate values, and represents if this AP is a stand-alone GW (e.g., there are no range extenders in this WiFi network, neither via Ethernet backhaul nor via WiFi mesh). It may be calculated as follows:

$${isAPStandAloneGW}_{t} = \{ \begin{matrix}1 & , & ! ( stats . {activeMesh}_{t} OR stats . {activeMesheth}_{t} ) \\ 0 & , & otherwise\end{matrix} \qquad Eq . 8$$

hasEthBackhaul is an example of the one or more intermediate values, and represents if at least one AP is connected to this AP via an Ethernet backhaul and no AP is connected to this AP via WiFi mesh backhaul. It may be calculated as follows:

$${hasEthBackhaul}_{t} = \{ \begin{matrix}1 & , & stats . {activeMesheth}_{t} AND NOT ( stats . WiFiBackhaul ) \\ 0 & , & otherwise\end{matrix} \qquad Eq . 9$$

hasWiFiBackhaul is an example of the one or more intermediate values, and represents if at least one AP is connected to this AP via Wi-Fi mesh backhaul. It may be calculated as follows:

$${hasWiFiBackhaul}_{t} = \{ \begin{matrix}1 , & stats . {activeMesh}_{t} \\ 0 , & otherwise\end{matrix} \qquad Eq . 10$$

are5STAInterfacesInDFS is an example of the one or more intermediate values, and represents if the 5 GHz STA-connectable interfaces of the AP that this STA is connected to are all in DFS channels or not.

An interface may be a 5 GHz STA-connectable interface if it is a 5 GHz interface and a STA is allowed to connect to this interface. There are four possible scenarios: 1) If an AP is a Dual-band AP or a Tri-band 6E AP, its 5 GHz STA-connectable interface is its 5 GHz interface; 2) If an AP is a Tri-band AP and it is a stand-alone GW, then both of its 5 GHz interfaces are 5 GHz STA-connectable interfaces; 3) If an AP is a Tri-band AP and at least one AP is connected to this AP via Wi-Fi mesh, then only the fronthaul 5 GHz interface is a 5 GHz STA-connectable interface; and/or, 4) If an AP is a Tri-band AP, at least one AP is connected to this AP via Ethernet backhaul and no AP is connected to this AP via Wi-Fi mesh, then both of its 5 GHz interfaces are 5 GHz STA-connectable interfaces.

are5STAInterfacesInDFS intermediate value may be calculated as follows:

$$are 5 {STAInterfacesInDFS}_{t} = isConnectedtoSingle 5 {GHzAP}_{t} \cdot is 5 {InDFS}_{t} + isConnectedtoTwo 5 {GHzAP}_{t} \cdot ( {hasWiFiBackhaul}_{t} \cdot is 5 {FHInDFS}_{t} + {isAPStandAloneGW}_{t} \cdot is 5 {FHInDFS}_{t} \cdot is 5 {BHInDFS}_{t} + {hasEthBackhaul}_{t} \cdot is 5 {FHInDFS}_{t} \cdot is 5 {BHInDFS}_{t} ) \qquad Eq . 11$$

Note that the following should hold for all devices:

$$isConnectedtoSingle 5 {GHzAP}_{t} + isConnectedtoTwo 5 {GHzAP}_{t} = 1$$

$${isAPStandAloneGW}_{t} + {hasWiFiBackhaul}_{t} + {hasEthBackhaul}_{t} = 1$$

isActive is an example of the one or more intermediate values, and represents if the STA is active at time slot t. It has a value of “1” if the STA is transmitting or/receiving more than a threshold (Minimum Traffic Threshold−τₜ), and “0” otherwise. It may be calculated as follows:

$${isActive}_{t} = \{ \begin{matrix}1 , & ( \begin{matrix}( rxbyte ( t ) - rxbyte ( t - 1 ) \geq {τ}_{t} ) \\ OR \\ ( txbyte ( t ) - txbyte ( t - 1 ) \geq {τ}_{t} )\end{matrix} ) \\ 0 , & otherwise\end{matrix} \qquad Eq . 12$$

Note, a Minimum Traffic Threshold may be parametric with a default value of 75000 bytes (e.g., 10 Kbps).

isIn24 is an example of the one or more intermediate values, and represents if the STA is connected to the 2.4 GHz interface of the associated AP at time slot t. It has a value of “1” if the STA is connected to the 2.4 GHz interface of its associated AP, and “0” otherwise. It may be calculated as follows:

$$isIn {24}_{t} = \{ \begin{matrix}1 , & band ( t ) == 2 \\ 0 , & otherwise\end{matrix} \qquad Eq . 13$$

isInRange5 is an example of the one or more intermediate values, and represents if the STA is within the range of the 5 GHz interface of its associated AP at time slot t. Note, for purposes of this example, it may be assumed that if a STA is within the range of the 6 GHz interface, it is also within the range of the 5 GHz interface. isInRangeShas a value of “1” if the STA is within range of the 5 GHz interface of its associated AP, and “0” otherwise. It may be calculated as follows:

$$isInRange {5}_{t} = \{ \begin{matrix}1 , & ( ! isIn {24}_{t} ) ∥ ( rssi 5 ( t ) \geq - 90 ) \\ 0 , & otherwise\end{matrix} \qquad Eq . 14$$

Note, rssi5(t) may be calculated using rssi(t) value as follows:

$$rssi 5 ( t ) = rssi ( t ) - {γ}_{c}$$

Here γ_{c} is the RSSI correction factor between 2.4 GHz and 5 GHz interfaces of the same AP. Its value may depend on the device type of the AP, as can be given in a table with a default value of −15 dBm.

In one or more cases, there may be one or more intermediate values generated one per STA.

is5Capable is an example of the one or more intermediate values, and represents if the STA supports 5 GHz WiFi PHY layer or not. It has a value of “1” if the STA is connected to a 5 GHz interface in the past, and “0” otherwise. Initial value of this intermediate value is “0”. It may be calculated as follows:

$$is 5 Capable = \{ \begin{matrix}1 , & ∃ band ( t ) == 5 : t ∈ [ 1 , now ] \\ 0 , & otherwise\end{matrix} \qquad Eq . 15$$

An alternative method of calculating this value may be based on a WLAN capability information collected from Wi-Fi association request frames sent from that STA. Among such events, if there is at least one WLAN capability event with a capability value of “5g”, is5Capable becomes “1”. However, in some cases, this method may have certain limitations and therefore may not be implemented.

In one or more cases, there may be one or more per slot analytics that may be generated on a 1-minute granularity using the intermediate values, as disclosed herein.

sufferFromDFS is an example of a one or more per slot analytics, and represents if the STA's performance has experienced a potential issue (i.e., suffering) due to its associated AP operating at a 5 GHz DFS channel at time slot t. It may be calculated as follows:

$${sufferFromDFS}_{t} = are 5 {STAInterfacesInDFS}_{t} \cdot {isActive}_{t} \cdot isIn {24}_{t} \cdot isInRange {5}_{t} \qquad Eq . 16$$

DFSCapChallenged is an example of a one or more per slot analytics, and represents if the STA's DFS capability has been challenged at time slot t. It shall be calculated as below:

$${DFSCapChallenged}_{t} = are 5 {STAInterfacesInDFS}_{t} \cdot {isActive}_{t} \cdot isInRange {5}_{t} \qquad Eq . 17$$

slotActive is an example of a one or more per slot analytic, and represents if the STA has been active during time slot t. It shall be calculated as below:

$${slotActive}_{t} = {isActive}_{t} \qquad Eq . 18$$

In one or more cases, there may be one or more per day analytics that may be generated on a 1-day granularity.

slotsSufferFromDFS is an example of one or more per day analytics, and represents the number of 1-minute slots the STA's performance has experienced a potential issue (i.e., suffering) due to its associated AP operating at a 5 GHz DFS channel during the last day provided the STA is a dual-band STA. It may be calculated as follows:

$$slotsSufferFromDFS = ( {\sum }_{t = 1}^{1440} {sufferFromDFS}_{t} ) \cdot is 5 Capable \qquad Eq . 19$$

slotsDFSCapChallenged is an example of one or more per day analytics, and represents the number of 1-minute slots the STA's DFS capability has been challenged during the last day provided the STA is a dual-band STA. It may be calculated as follows:

$$slotsDFSCapChallenged = ( {\sum }_{t = 1}^{1440} {DFSCapChallenged}_{t} ) \cdot is 5 Capable \qquad Eq . 20$$

slotsNonSufferFromDFS is an example of one or more per day analytics, and represents the number of 1-minute slots the STA's DFS capability has been challenged and the STA was able to connect (i.e., did not experience any issue) to a 5 GHz interface of its associated AP. It may be calculated as follows:

$$slotsNonSufferFromDFS = slotsDFSCapChallenged - slotsSufferFromDFS \qquad Eq . 21$$

slotsActive is an example of one or more per day analytics, and represents the number of 1-minute slots the STA had been active during the last day provided the STA is a dual-band STA. It may be calculated as follows:

$$slotsActive = ( {\sum }_{t = 1}^{1440} {slotsActive}_{t} ) \cdot is 5 Capable \qquad Eq . 22$$

For example, the MC may have a period of operation the same as the period of the DCCEOperationPeriod parameter.

The DCCE Activity-Weighted Channel Capabilities Determination (AW-CCD) module may have one or more operational requirements, operating parameters, and/or may perform one or more actions.

For example, the AW-CCD may have a list of all STAs within the cloud development environment.

For example, the AW-CCD may have, for each STA, access to the Type value and/or Per Day analytics.

For example, the AW-CCD may have modules each working for a particular Type value and generating a Boolean Activity-Weighted DFS capability (AW-DFS) flag for each STA. In one instance, instead of a single boolean value representing activity weighted DFS capability of a STA, there may be a channel capability bitmap representing activity weighted capability for each channel.

For example, the AW-CCD may have a type-module association table determining which module should work for which type of STAs.

For example, the AW-CCD may have a type-module association table, that is configurable on a cloud development basis.

For example, the AW-CCD may have a default value for the type-module association, such as shown in the example provided in Table 5.

TABLE 5
Default Type - module association table

| Type | Module |
|---|---|
| TypeA | TypeA Static Module |
| Unknown | Band Usage Analyzer Module |

For example, the AW-CCD may periodically process all STAs with the module associated with their type in the Type—module association table.

For example, the AW-CCD may have a period of operation the same as the period of the DCCEOperationPeriod parameter.

For example, the AW-CCD may have TypeA Static module, as disclosed herein.

For example, the AW-CCD may have a Band Usage Analyzer module, as disclosed herein.

For example, the AW-CCD may have a TypeA API Module, as disclosed herein.

For example, the AW-CCD may generate (e.g., monitor, collect information, measure or request measurements, determine, etc.) Logs, generated as described herein.

The TypeA Static Module may have one or more operational requirements, operating parameters, and/or may perform one or more actions.

For example, the TypeA Static module may use the knowledge collected from the field as well as given (e.g., sent) by a particular TypeA that all that TypeA's devices are unable to operate at DFS channels. In some instances, field means information gathered by a particular TypeA or gathered from the field.

For example, the TypeA Static module may utilize the slotsActive Per Day analytic and decide on the AW-DFS flag as shown in Table 6.

TABLE 6
Pseudocode for TypeA Static AW-CCD module

| | |
|---|---|
| 1: | if (slotsActive ≥ τ_{act}) |
| 2: | AW-DFS flag = true |
| 3: | else |
| 4: | AW-DFS flag = false |

For example, the TypeA Static module may use a Minimum activity threshold (τ_{act}) that is a cloud development-wide configurable parameter, which may have a default value of 4.

The Band Usage Analyzer Module may have one or more operational requirements, operating parameters, and/or may perform one or more actions.

For example, the Band Usage Analyzer may utilize slotsSufferFromDFS, slotsDFSCapChallenged, slotsNonSufferFromDFS, and/or slotsActive Per Day analytics as well as a per-STA state information to decide on the AW-DFS flag.

For example, the Band Usage Analyzer may keep (e.g., collect, monitor, determine) a state information for each STA. The state may be “Unknown”, “Capable”, “Incapable”, and/or “Inactive”.

For example, the Band Usage Analyzer may have a new STA to start with the “Unknown” state.

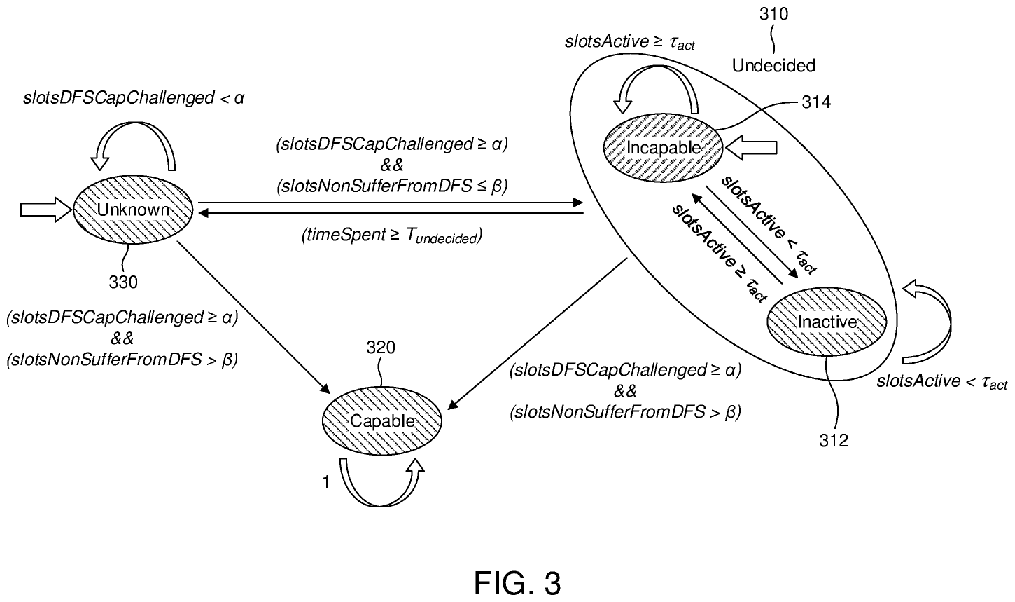

For example, the Band Usage Analyzer may perform one or more assessments, such as shown in a state transition diagram as that depicted in the example of FIG. 3, to decide on the AW-DFS flag as shown in Table 7.

TABLE 7
Pseudocode for Band Usage Analyzer AW-CCD module

| | |
|---|---|
| 1: | if (state ∈ {Incapable}) |
| 2: | AW-DFS flag = true |
| 3: | else |
| 4: | AW-DFS flag = false |

FIG. 3 illustrates an example diagram of station transition algorithm (e.g., performed by the DCCE). There may be one or more approaches to determining a state for a given STA in a wireless network. In one example, as shown, there may be an algorithm that depends on one or more statistics (e.g., as previously gathered). The algorithm may be executed by a DCCE for the purposes of subsequently sending instructions to a wireless network (e.g., as part of a cloud controlled network) to modify the channel usage in the network.

As illustrated, there may be four states, (unknown 330, capable 320, inactive 312, and incapable 314, etc.). The solid black arrows illustrate a transition between the different states, and the large white arrows illustrate initial states. The algorithm may be calculated periodically (e.g., daily, etc.) or dynamically (e.g., based on a trigger, such as one or more conditions/metrics discussed herein). For each state assessment, there may be a related threshold (e.g., alpha, beta, tau, etc.) as discussed herein. The threshold may be used to assess a given metric or combination of metrics (e.g., intermediate value, analytic, etc., as discussed herein) to determine whether a state change takes place.

In one example, a new state may be assigned/determined each day, and at the end of each assessment day, and the assessment/determination may start from wherever it ended. Generally speaking, once you have made it to a capable state, the state may not change.

In an example as shown, a state may start at unknown 330. If the slotsDFSCapChallenged is less than alpha, then the state may remain at unknown. If the slotsDFSCapChallenged is greater than or equal to alpha, and slotsNonSufferFromDFS is greater than beta, then the state may transition to capable 320. If the slotsDFSCapChallenged is greater than or equal to alpha, and slotsNonSufferFromDFS is less than or equal to beta, then the state may transition to undecided 310. If timeSpent is greater or equal to a T_{undecided} then the state may transition back to unknown.

The undecided state may have two states, incapable 314 and inactive 312. Similar to the unknown state 330, when the state is in undecided 310 and If the slotsDFSCapChallenged is greater than or equal to alpha, and slotsNonSufferFromDFS is greater than beta, then the state may transition to capable 320.

Internal to undecided 314, if slotsActive is less than tau_act, then the state may be inactive. If slotsActive is greater or equal to tau_act, then the state may be incapable.

In one instance, the example of FIG. 3 may apply to the Band Analyzer. In another instance, an example similar to FIG. 3 may apply to another module, whereby a state is determined off of one or more metrics, and the relationship between these metrics ultimately determine the channel decision.

For example, the Band Usage Analyzer may utilize a Minimum activity threshold (τ_{act}) that is a cloud development-wide configurable parameter, which may have a default value or 4.

For example, the Band Usage Analyzer may utilize a Minimum DFS capability challenged slot count and/or Minimum DFS suffering slot count, which one or both may be a cloud development-wide configurable parameter, which may have the same value and may be represented by a whose may have a default value or 4.

For example, the Band Usage Analyzer may utilize a Maximum allowed slotsNonSufferFromDFS value that is a cloud development-wide configurable parameter represented by f that may have a default value of 0.

For example, the Band Usage Analyzer may utilize a Retention timeout time for DFS Incapable/Inactive STAs value that is a cloud development-wide configurable parameter represented by T_{undecided} which may have a default value of 30 days.

For example, the Band Usage Analyzer may have any STA that is in a “Capable” state always stay at this state.

For example, the Band Usage Analyzer have the state information of any STA is kept/stored for a long time (e.g., 1 year).

The TypeA API module may have one or more operational requirements, operating parameters, and/or may perform one or more actions.

For example, the TypeA API may depend on an external API, which may be queried on a per-STA identification parameters. This external API may be provided by the company owning the STAs.

For example, the TypeA API may have an external API, which may return a flag value (isDFSIncapable) that has a “true” value if the queried STA cannot operate at DFS channels, and a false” value if the queried STA can operate at DFS channels.

For example, the TypeA API may utilize the per-STA isDFSIncapable flag as well as the slotsActive Per Day analytic, and use one or more of those to decide on the AW-DFS flag as shown in Table 8.

TABLE 8
Pseudocode for TypeA API AW-CCD module

| | |
|---|---|
| 1: | if (slotsActive · isDFSIncapable ≥ τ_{act}) |
| 2: | AW-DFS flag = true |
| 3: | else |
| 4: | AW-DFS flag = false |

For example, the TypeA API may use a Minimum activity threshold (τ_{act}) that is cloud development-wide configurable parameter, which may have a default value of 4.

The DCCE WMN-wide Channel Capability Determination (WCCD) module may have one or more operational requirements, operating parameters, and/or may perform one or more actions.

For example, the WCCD may have a list of all STAs, a list of all WMNs, as well as a WMN ID of each STA within the cloud development environment (e.g., the entire cloud, including the CNC and the DCCE).

For example, the WCCD may, for each STA, have access to the AW-DFS flag value.

For example, the WCCD may periodically process all WMNs by checking the AW-DFS flags of each STA within the WMN and decide on a WMN-based DFS Capability Flag as shown in the example of Table 9:

TABLE 9
Pseudocode for WCCD component

| | |
|---|---|
| 1: | WMN DFS Capability Flag = true |
| 2: | for (each STA i in WMN) |
| 3: | if (AW-DFS flag of i == false) |
| 4: | WMN DFS Capability Flag = false |
| 5: | end for |

For example, the WCCD may have a period of operation that may be that same period as the DCCEOperationPeriod parameter.

The DCCE may have one or more configurable parameters, such as shown in Table 10. For example, each parameter may have a range of values. In some instances, each parameter may have a default value, as shown in the example of Table 10.

TABLE 10
DCCE Configurable parameters default values

| Parameter | Configurable? | Value | |
|---|---|---|---|
| TypeA OUI list | Yes | As in Table 3 | |
| [symbol] _{DFS} | Yes | As in Table 4 | |
| DCCEOperationPeriod | No | 1 | day |
| τₜ | Yes | 75000 | bytes |
| τ_{act} | Yes | 4 | |
| α | Yes | 4 | |
| β | Yes | 0 | |
| T_{undecided} | Yes | 30 | days |

Based on one or more examples described herein, the CACS module of the CNC, including for example the Channel Optimizer module of the CACS, may interact with the DCCE of the DCC. Such interaction may include the use of one or more parameters and include the performance of one or more actions.

For example, the interaction may include the DCCE, after its periodic operation, passing the WMN-based DFS Capability Flag value for each WMN to the Channel Optimizer module of the CACS. Passing means herein from one entity in the computer environment to another; in some cases it may be separate physically, or separate virtually. For example, the DCCU and the channel optimizer module of the CACS may operate on the same processor or different processors; they may be local or separate.

For example, the interaction may include the Channel Optimizer, For each WMN, changing the banned channel list to be used in the CACS module based on the WMN-based DFS Capability Flag value.

For example, for dual-band APs, if the WMN-based DFS Capability Flag is true, the channel given in [symbol] _{DFS} (e.g., as in Table 4) may be removed from the banned channel list of that WMN. Then, the banned channel list for that WMN may be set to the deployment-wide default banned channel list. If the WMN-based DFS Capability Flag is false, the channels given in [symbol] _{DFS} (e.g., as in Table 4) may be added to the banned channel list of that WMN.

For example, for tri-band APs, if the WMN-based DFS Capability Flag is true, the channel given in [symbol] _{DFS} (e.g., as in Table 4) may be removed from the banned channel list for the fronthaul interface of that WMN. Then, the banned channel list for the fronthaul interface of that WMN may be set to the deployment-wide default banned channel list. If the WMN-based DFS Capability Flag is false, the channels given in [symbol] _{DFS} (e.g., as in Table 4) may be added to the banned channel list for the fronthaul interface of that WMN.

For example, the interaction may include the Channel Optimizer (e.g., only) taking the WMN-based DFS Capability Flag values into consideration (e.g., as described herein if the “DCCE_Enabled” configuration is set to “True”). Otherwise, it may disregard the output of the DCCE.

There may be one or more available configuration parameters for the DCCE, and/or one or more of the DCCE modules. These configurations are shown in the examples of Table 11, 12, 13, and 14. Whoever uses the DCC may set these configuration parameters according to the needs of the target environment and/or STA type. This may be configured through a cloud interface, UI. The values (e.g., OUI list, client Type determination rules, etc.) may change from deployment to deployment.

Table 11 provides an example of a TypeA OUI list, which is a list of the OUIs defining if a device is a TypeA device (e.g., one or more of these values may be a default value). Table 11 also provides an example of a DFS channel list, which is a list of the DFS channels in the 5 GHz band (e.g., one or more of these values may be a default value).

TABLE 11
Lists

| TypeA OUI | D04D2C, B0A737, B0EE7B, D83134, 105932, A8B57C, |
|---|---|
| list | B8A175, 88DEA9, 000D4B, 20EFBD, 080581, C83A6B, |
| | 8C4962, BCD7D4, AC3A7A, B83E59, DC3A5E, |
| | ACAE19, CC6DA0, 84EAED, D4E22F, 7C67AB |
| DFS channel | 52, 56, 60, 64, 100, 104, 108, 112, 116, 120, |
| list | 124, 128, 132, 136, 140, 144 |

Table 12 show an example client type determination rule, which lists all the available rules to determine device types as a 4-tuple: name, comparison logic, type, and priority, as explained further herein. This example only demonstrates only one type, which is “TypeA”. However, in some circumstances, there may be a plurality of types. Even though only one type is discussed herein, it is intended that there may be more than one type in some circumstances (e.g., TypeB, TypeC, etc.).

TABLE 12
Client Type Determination Rules

| name | TypeA OUI rule |
|---|---|
| comparison logic | OUI of MAC address is within TypeA OUI list |
| type | TypeA |
| priority | 1 |
| name | TypeATV rule |
| comparison logic | Friendly name contains “TypeATV” |
| type | TypeA |
| priority | 2 |

Table 13 provides an example of Activity Weighted Channel Capabilities Determination module associations, which lists the current module association rule for each type of device. Each row explains which type of device it is used for as well as the associated module. This example only demonstrates two modules, which are “TypeA Static” and “Band Usage Analyzer”. However, in some circumstances, there may a plurality of modules as it relates to module association. Even though only two are discussed with regard to this example, it is intended that there may be more than two in some circumstances (e.g., other modules described herein). In one example, the default values may be those provided in Table 13.

TABLE 13
Activity-Weighted Channel Capabilities
Determination Module Association

| TypeA | TypeA Static |
|---|---|
| Unknown | Band Usage Analyzer |

Table 14 provides an example of band-usage-analyzer configuration. In one instance, one or more of the values provided in this table may be a default value. The alpha value may set the value for the Minimum DFS capability challenged slot count and/or the Minimum DFS suffering slot count, as further discussed herein. The beta value may set the value for Maximum allowed slotsNonSufferFromDFS, as further discussed herein. The tau_act value may set the value for the minimum activity threshold to compare the daily slotsActive analytic, as further discussed herein. The tau_t value may set the value for the minimum traffic threshold used in the calculation of the intermediate value, isActive, as further discussed herein. The T_undecided value may set the value for Retention timeout time for DFS Incapable/Inactive STAs, as discussed further herein.

TABLE 14
Band-Usage-Analyzer - rssi_correction_factors

| alpha: | 4 | |
|---|---|---|
| beta | 0 | |
| tau_act: | 4 | |
| tau_t: | 75000 | # bytes |
| T_undecided | 30 | Days |

Table 15 provides an example of band-usage-analyzer configuration. The rssi_correction_factors lists the RSSI correction factors used to calculate the rssi(t) values from the measured rssi5(t) values in different device types. For each device type there may be a pair composed of name of the device type and the associated correction factor. The “default: −15” item represents the correction factor that may be used for any devices for which no correction factor has been explicitly stated. There may always be an item with “default”.

TABLE 15
Band-Usage-Analyzer - rssi_correction_factors

| | |
|---|---|
| Product 1 | −10 # dBm |
| Product 2 | −11 # dBm |
| default: | −15 # dBm |

As described herein, the AW-DFS module of the DCCE may performing logging. The logging may be in one or more formats, where the formats provide additional modular utility.

For example, concerning the logging format, when enabled by the data path XXXX, after its operation the AW-DFS module may generate a report on a home basis where logs belonging to each type of devices may be grouped together, thereby providing additional information relative to later analysis.

For example, the overall format of a home-based logs may be as follows:
Home<HomeID>:{<Type #1>: {Type #1 Log Format}, . . . , <Type #N>: {Type #N Log Format}}

Where <Type #X> may refer to the name of the Type and <Type #X Log Format> refers to the log format that may be used for this type, as further described herein.

For example, the format of the “TypeA” type of devices (e.g., where the Type field has the “TypeA” value) may be as below:
TypeAs: {<MAC>, <ActivityStatus>}, . . . {<MAC>, <ActivityStatus>}

Where <MAC> refers to the MAC address of the client device, <Activity Status> can either be “Active” if slotsActive≥τ_{act} and “Inactive if “slotsActive<τ_{act}.

For example, the format of the “Unknown” type of devices (i.e., where the Type field has the “Unknown” value) may be as follows:
Unknown: {<MAC>, <State>, <per day analytics>}, . . . , {<MAC>, <State>, <per day analytics>}

Where <MAC> refers to the MAC address of the client device, <State> refers to the state of the client device among the states given FIG. 3, <per day analytics> refers to the values of the slotsSufferFromDFS, slotsDFSCapChallenged, slotsNonSufferFromDFS, and slotsActive values of the device. These<per day analytics> shall only exist if the state is not “Capable”.

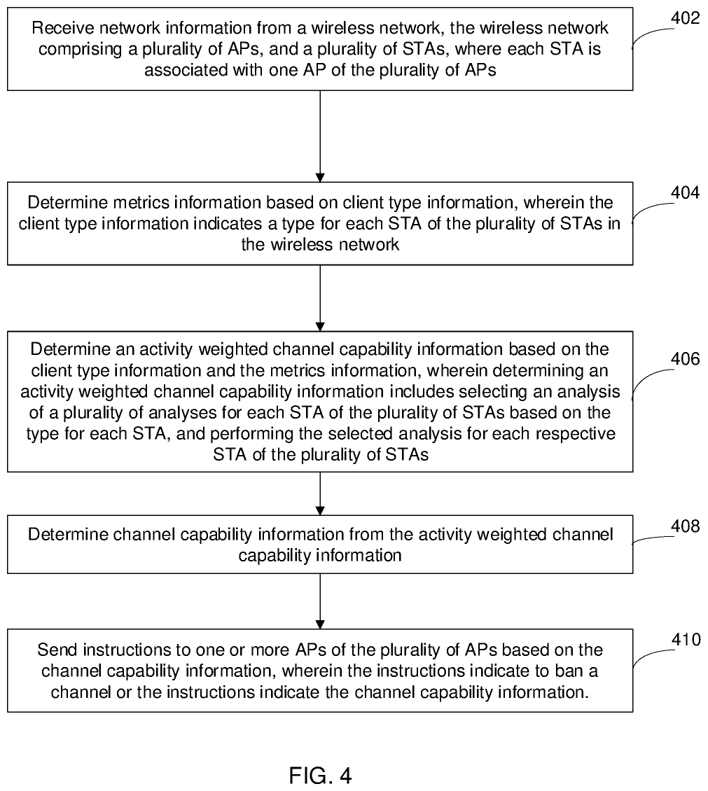

FIG. 4 illustrates an example process based on one or more examples described herein. In this example, a DCC running on a processor operatively couple to a transceiver (e.g., a communication means of wired or wireless), may perform a method. The DCC may receive network information from a wireless network, the wireless network comprising a plurality of APs, and a plurality of STAs, where each STA is associated with one AP of the plurality of APs. The DCC may determine metrics information based on client type information, wherein the client type information indicates a type for each STA of the plurality of STAs in the wireless network. The DCC may determine an activity weighted channel capability information based on the client type information and the metrics information, wherein determining an activity weighted channel capability information includes selecting an analysis of a plurality of analyses for each STA of the plurality of STAs based on the type for each STA. The DCC may perform the selected analysis for each respective STA of the plurality of STAs. The DCC may determining channel capability information based on one or more of the previous steps (e.g., for an entire network or for one or more APs). The DCC may send instructions to one or more APs of the plurality of APs based on the channel capability information, wherein the instructions indicate to ban a channel or the instructions indicate the channel capability information. In one instance, determining client type information may include processing identification information for each STA in the wireless network and determining the type of each STA in the wireless network. In one instance, determining metrics information may include generating one or more slot analytic values for each STA in the wireless network. In one instance, determining an activity weighted channel capability information may be based on one or more slot analytic values. In one instance, performing the selected analysis for each respective STA of the plurality of STAs may include determining to generate a flag for each respective STA of the plurality of STAs. In one instance, determining channel capability information may be based on aggregating any flags that were determined to be generated, and determining to generate a flag for the wireless network may be based on the aggregating. In one instance, the DCC performs the method in conjunction with one or more of a cloud computer and/or a cloud based network controller. Elements 402-410 may apply to one or more steps recited above.

Although features and elements are described above in particular combinations (e.g., embodiments, methods, examples, etc.), one of ordinary skill in the art will appreciate that each feature or element can be used alone or in any combination with the other features and elements disclosed herein. For example, as disclosed herein there may be a method described in association with a figure for illustrative purposes, and one of ordinary skill in the art will appreciate that one or more features or elements from this method may be used alone or in combination with one or more features from another method described elsewhere (e.g., with regard to another figure, or another example). A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a computer, a user device, STA, AP, cloud based system, a terminal, base station, network node, or any other type of processor base device.

What is claimed:

1. A method comprising:
receiving network information from a wireless network, the wireless network comprising a plurality of APs, and a plurality of STAs, where each STA is associated with one AP of the plurality of APs;
determining metrics information based on client type information, wherein the client type information indicates a type for each STA of the plurality of STAs in the wireless network;
determining an activity weighted channel capability information based on the client type information and the metrics information, wherein determining an activity weighted channel capability information includes selecting an analysis of a plurality of analyses for each STA of the plurality of STAs based on the type for each STA, and performing the selected analysis for each respective STA of the plurality of STAs;
determining channel capability information from the activity weighted channel capability information; and
sending instructions to one or more APs of the plurality of APs based on the channel capability information, wherein the instructions indicate to ban a channel or the instructions indicate the channel capability information.

2. The method of claim 1, wherein determining client type information includes processing identification information for each STA in the wireless network and determining the type of each STA in the wireless network

3. The method of claim 2, wherein determining metrics information includes generating one or more slot analytic values for each STA in the wireless network.

4. The method of claim 3, wherein determining an activity weighted channel capability information is based on one or more slot analytic values.

5. The method of claim 4, wherein performing the selected analysis for each respective STA of the plurality of STAs includes determining to generate a flag for each respective STA of the plurality of STAs.

6. The method of claim 5, wherein determining wireless network wide channel capability information is based on aggregating any flags that were determined to be generated, and determining to generate a flag for the wireless network based on the aggregating.

7. The method of claim 6, wherein the method is performed by one or more of a cloud computer, a cloud based network controller, or a dynamically channel capability engine.

8. A device comprising:
means for receiving network information from a wireless network, the wireless network comprising a plurality of APs, and a plurality of STAs, where each STA is associated with one AP of the plurality of APs;
means for determining metrics information based on client type information, wherein the client type information indicates a type for each STA of the plurality of STAs in the wireless network;
means for determining an activity weighted channel capability information based on the client type information and the metrics information, wherein determining an activity weighted channel capability information includes selecting an analysis of a plurality of analyses for each STA of the plurality of STAs based on the type for each STA, and performing the selected analysis for each respective STA of the plurality of STAs;
means for determining channel capability information from the activity weighted channel capability information; and
means for sending instructions to one or more APs of the plurality of APs based on the channel capability information, wherein the instructions indicate to ban a channel or the instructions indicate the channel capability information.

9. The device of claim 8, wherein determining client type information includes processing identification information for each STA in the wireless network and determining the type of each STA in the wireless network.

10. The device of claim 9, wherein determining metrics information includes generating one or more slot analytic values for each STA in the wireless network.

11. The device of claim 10, wherein determining an activity weighted channel capability information is based on one or more slot analytic values.

12. The device of claim 11, wherein performing the selected analysis for each respective STA of the plurality of STAs includes determining to generate a flag for each respective STA of the plurality of STAs.

13. The device of claim 12, wherein determining wireless network wide channel capability information is based on aggregating any flags that were determined to be generated, and determining to generate a flag for the wireless network based on the aggregating.

14. The device of claim 13, wherein the device is a cloud computer, a cloud based network controller, or a dynamically channel capability engine.
